(19) United States
(12) Patent Application Publication
(10) Pub. No.: US 2006/0293907 A1
(43) Pub. Date: Dec. 28, 2006

(54) Method for generating custom postage stamps

(76) Inventor: George A. Castineiras, Farmington, CT (US)

Correspondence Address: MICHAUD-DUFFY GROUP LLP, 306 INDUSTRIAL PARK ROAD, SUITE 206, MIDDLETOWN, CT, 06457, US

(21) Appl. No.: 11/168,651

(22) Filed: Jun. 27, 2005

(51) Int. Cl. G06Q 99/00; G06F 17/00; G07B 17/02

(52) U.S. Cl. 705/1; 705/402

(57) ABSTRACT

In a method for offering custom postage stamps as a fundraiser, a particular organization is targeted as a candidate for a fundraising event whereby custom postage stamps, having original artwork thereon, will be sold, the original artwork being created by members of said organization. Guidelines are provided to the organization regarding the manner in which the original artwork is to be created. The original artwork is created and collected. Postage stamps having the original artwork thereon are offered for sale. Orders for the postage stamps are received and the original artwork is imaged onto the postage stamps. Payment is processed for the orders and the postage stamps are delivered to the purchasers thereof.

### FIELD OF THE INVENTION

The present invention relates generally to the conduct of fundraising activities, and is more specifically directed to a fundraiser whereby postage stamps having original artwork thereon are offered for sale, the original artwork being produced by members of the organization benefiting from the fundraiser.

### BACKGROUND OF THE INVENTION

Institutions such as schools, churches, charities, and the like often use fundraising activities to generate the capital needed to offer services or even to continue in existence. These activities typically require a great deal of planning and time to implement. In addition, they are usually “one-time” activities wherein a continuous revenue stream stemming therefrom is not realizable. In addition, these fundraising activities often have limited appeal to large population segments. Moreover, they can be logistically cumbersome as the items sold are sometimes perishable and must be gathered in a common location for distribution or to be picked up. Furthermore, the items offered for sale as part of a fundraiser are sometimes large and consume a great deal of space.

Most fundraisers offer items that are not useable year round on a continuous basis. Accordingly, the need to replenish such items is minimal. In addition, it has been historically difficult for institutions to maintain a sustained year-round fundraising effort. Personnel and other logistical considerations make an ongoing campaign difficult. This is particularly true where the personnel conducting the fundraising activity consist of volunteers who may have competing obligations.

There is a current need to provide a mechanism through which an organization can conduct a sustainable fundraising event having wide appeal. To facilitate such a fundraiser, the item offered for sale must be something most people have an ongoing need for and must be easily handled. The item offered must also be something that will catch the attention of potential purchasers by, for example, being personalized.

Based on the foregoing, it is the general object of the present invention to provide a manner by which institutions and organizations can conduct fundraising activities that overcome the problems and drawbacks of prior art activities.

### SUMMARY OF THE INVENTION

The present invention resides in one aspect in a method for producing custom postage stamps to be used as part of a fundraising activity. Particular organizations are initially targeted as candidates for the fundraising event which includes the sale of customized postage stamps that have original artwork, created by members of the organization, thereon. Guidelines are provided to the organization regarding the manner in which the original artwork is to be created. The artwork is then collected and postage stamps having the original artwork thereon are offered for sale by the organization. Orders are received for the custom postage stamps and then images of the original artwork are transferred onto the stamps. The custom postage stamps are then delivered to the purchasers.

In a preferred embodiment of the present invention, the organization is a school and the members of the organization are the students enrolled in the school. Each student creates his or her own original artwork to be imaged onto a postage stamp. Once created, the original artwork is collected either manually and brought to, or transferred electronically to, a processing location. At this location, the original artwork is converted into a digital format and stored in the memory of a computer. Preferably, personalized promotional brochures are then created that exhibit an individual student's original artwork thereon. These personalized brochures are provided to each student along with order forms, to allow the students to offer their custom stamps for sale. The order forms will be processed and payment received preferably via credit card or using an internet payment service such as PayPal®. Once the orders are processed, the custom stamps are then produced and either mailed directly to the purchaser or the stamps are provided to the school for subsequent distribution. Once ordered, the custom stamps may be reordered as desired either by the school, or directly by individual purchasers. In either situation, the school would receive a portion of the proceeds. While a school has been described, the present invention is not limited in this regard as any organization, including, but not limited to, non-profits and charities are also applicable.

Once the fundraiser has been completed, the school will be given a printed poster of each stamp produced by grade level. The poster will highlight the top stamp based on sales and artwork. In addition, an art critic will select the most artistic stamp based on each grade level. Prizes will be awarded to at least the top seller and most artistic. Prizes may also be awarded if certain sales milestones are attained. Moreover, collectors' versions of a student's stamp will be made available for purchase with the ability to purchase the collectors' editions for subsequent years.

Where several schools are involved in the fundraising activity, national awards for the most artistic stamps in particular categories and grade levels can be given.

In another embodiment of the present invention, a kiosk positioned in a public area, such as, but not limited to, a shopping mall has a computer programmed to allow a user to design and print custom postage stamps located therein. During operation, a user can input graphical information corresponding to images they wish put onto a custom stamp into the computer. A custom postage stamp having the desired image thereon is displayed on a screen in communication with the computer. Once the user is satisfied with the image, payment for the custom postage stamps is tendered and they are dispensed at the kiosk. The user can also have the option of having the stamps printed onto postcards, or directly onto envelopes.

The kiosk can also include a photo booth where photographs of one or more individuals can be taken and downloaded directly into memory forming part of the computer located in the kiosk. The user can then alter the pictures at the computer using morphing software, or the user can add to the picture or incorporate text thereon. In addition, a caricature artist can be present in the kiosk for making fanciful pictures of one or more individuals. These caricatures can then be scanned into the computer memory and imaged onto a custom postage stamp. Once the user is satisfied with the image, payment for the custom postage stamps is tendered and they are dispensed at the kiosk. The user can also have the option of having the stamps printed onto postcards, or directly onto envelopes. In addition, custom stationery can be printed.

### BRIEF DESCRIPTION OF THE DRAWINGS

FIG. 1 is a flow chart illustrating a method of the present invention involving a school and the generation of original artwork by the school's students for placement onto stamps.

FIG. 2 schematically illustrates a method of the present invention involving the generation of custom postage stamps at a kiosk located in a publicly accessible area.

### DETAILED DESCRIPTION OF THE PREFERRED EMBODIMENTS

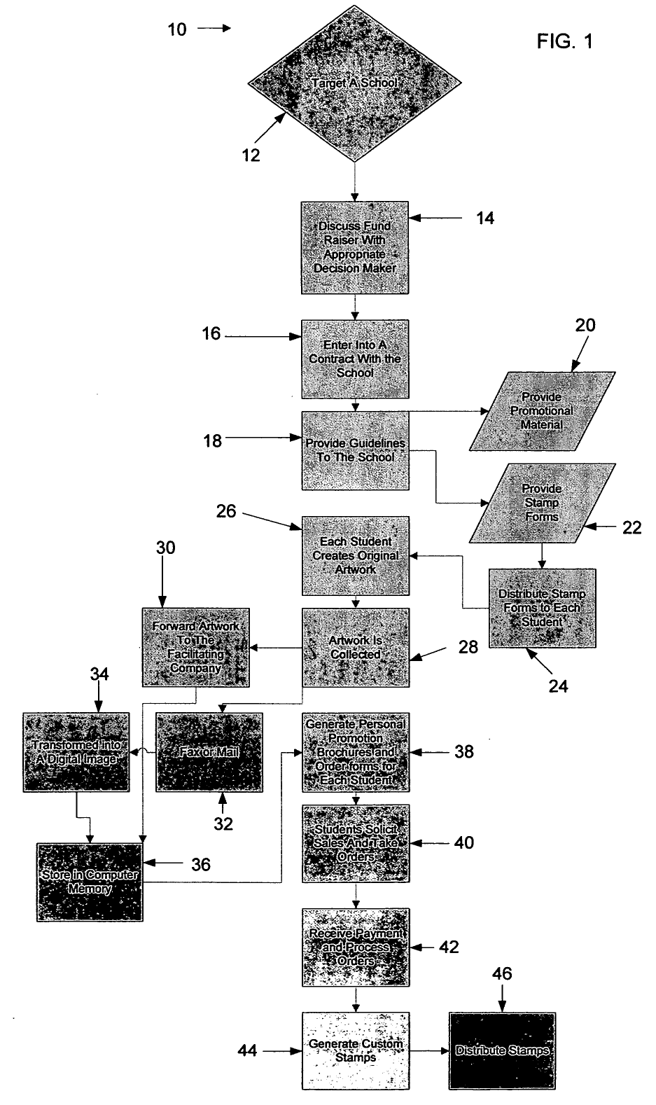

As shown in the flow chart of FIG. 1, a method in accordance with the present invention is generally designated by the reference number 10. In the method 10 and as part of a fundraising activity, students in a school each generate original artwork to be used on a postage stamp. The method begins by approaching, or being approached by, a particular school or school system 12. Public, private and nursery schools are all contemplated by the present invention; however, the present invention is not limited in that regard as any organization can also employ the methods disclosed herein without departing from the broader aspects of the invention.

Referring back to FIG. 1, once the organization has expressed an interest in conducting a fundraiser in accordance with the present invention, the fundraiser is discussed with the appropriate decision makers within the school 14. The decision makers could include the school principal, the Parent Teacher Organization, the Board of Education, or others. If the school decides to conduct the fundraiser, a contract is entered into between the school and the company facilitating the fundraiser 16. The facilitating company then provides the school with guidelines 18 as to how to conduct the fundraisers. Included within these guidelines are promotional materials 20, such as, but not limited to, posters and brochures, as well as stamp forms 22 upon which the students will each create their own individual artwork. In addition, the guidelines will provide information to the students and faculty of the school regarding what is acceptable original artwork.

Following distribution of the guidelines, the school then distributes one or more stamp forms to each student 24 who then creates his/her own artwork 26 on the stamp form. Once created, the original artwork is collected 28 and forwarded to the facilitating company 32. The original artwork can be forwarded in any one of several different ways. For example, the artwork can be mailed or faxed to the distributing company 32. The original artwork can also be scanned or digitally photographed and then e-mailed to the facilitating company. Once the original artwork is received by the facilitating company, if it is not already in a digital format, it is put into digital format 34 and stored in the memory of a computer 36.

Upon approval of each individual piece of original artwork, personal promotional brochures are produced 38 from the images stored in computer memory, preferably depicting the individual student's artwork on a postage stamp. The personal brochures are provided to each student along with order forms. These brochures can be provided in hard copy or can be electronically transferred via e-mail to the school for subsequent printing. Each student then solicits orders 40. The orders can be collected at the school and forwarded in bulk to the facilitating company, or the orders can be forwarded directly from each student to the facilitating company.

Preferably, as part of the ordering process, a purchaser provides the student, on the order form, with a credit card number. However, the present invention is not limited in this regard as checks or cash may also be accepted. In addition, once ordering information is received, the facilitating company can forward via e-mail payment information to a purchaser with instructions to then forward credit card payment over the internet or to use a payment processor such as PayPal® which securely processes payments between purchaser and purchasee 42.

Once payment is received, the custom stamps are then generated 44 and forwarded to either the purchaser, or to the school for subsequent distribution 46. Once a custom stamp is generated, it can be subsequently reordered by a purchaser or by the school system. A portion of the proceeds from each order go to the school system. Depending on quantities ordered, the percentage of the sale price that goes to the school can vary. In addition, the fundraiser can also include cash or prize incentives as awards for high sales.

While the above-described method involves each student's artwork being imaged onto a postage stamp, the present invention is not limited in this regard. The fundraiser can also include a competition where one or a finite number of original pieces of artwork are selected from submissions from all of the students. For example, once the fundraiser has been completed, the school can be given a printed poster of each stamp produced by grade level. The poster can be produced to highlight the top stamp based on sales and artwork. In addition, an art critic can be utilized to select the most artistic stamp based on each grade level. Prizes can be awarded to at least the top seller and most artistic. Prizes may also be awarded if certain sales milestones are attained. Moreover, collector's versions of a student's stamp can be made available for purchase with the ability to purchase the collectors editions for subsequent years. Where several schools are involved in the fundraising activity, national awards for the most artistic stamps in particular categories and grade levels can be given.

In addition, cards or stationery bearing the student's original artwork can also be provided.

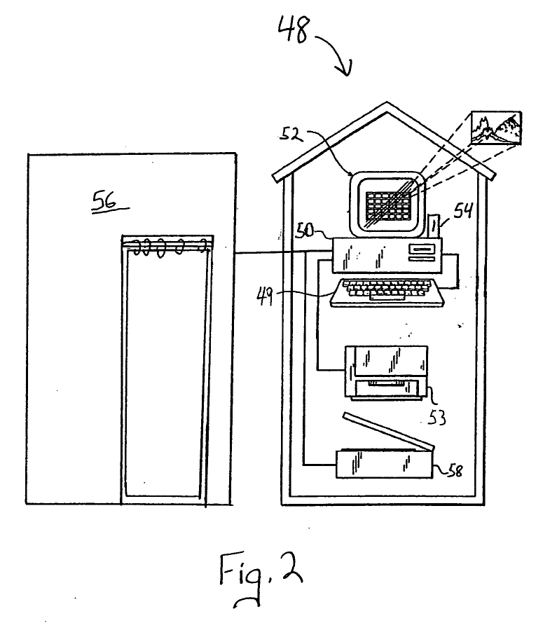

As shown in FIG. 2, a kiosk 48 is positioned in a publicly accessible location, such as, for example, a shopping mall. A computer 50 programmed to allow a user to design and print custom postage stamps is located in the kiosk 48. During operation, a user can input via a keyboard 49 or by other known means, graphic information corresponding to indicia a user desires to have imaged onto a postage stamp into said computer. The input information is displayed on a screen 52 in communication with the computer 50. Once satisfied, the customer then pays for the custom postage stamps and they are then printed on a printer 53 at the kiosk 48. The kiosk 48 can be manned, or the process can be entirely automated with payment being via credit card which can be swiped through a card reader 54 in communication with the computer 50. The user can be provided with the option of having the stamps printed directly, or having envelopes or postcards supplied with the custom postage indicia printed directly thereon. Custom stationery can also be provided at the kiosk.

A photo booth 56 can also be provided in the kiosk 48 so that one or more individuals can have their photographs taken and then stored in memory forming part of the computer 50. A user can then access the photographs on the computer 50 and manipulate the images by using morphing software or by adding other graphics and/or text to the images. As described above, once satisfied the desired stamps are paid for and printed at the kiosk 48. In addition to, or in lieu of, the photo booth 56, a caricature artist can be present in the kiosk 48 and can create caricatures which are then scanned using a scanner 58 into the computer memory for imaging, as described above, onto a postage stamp, envelope, or the like.

Although this invention has been shown and described with respect to the detailed embodiments thereof, it will be understood by those of skill in the art that various changes may be made and equivalents may be substituted for elements and steps thereof without departing from the scope of the invention. In addition, modifications may be made to adapt a particular situation to the teachings of the invention without departing from the essential scope thereof. Therefore, it is intended that the invention not be limited to the particular embodiments disclosed in the above detailed description, but that the invention will include all embodiments falling within the scope of the above description.

What is claimed is:

1. A method for offering custom postage stamps as a fundraiser, said method comprising the steps of:
targeting a particular organization as a candidate for a fundraising event whereby custom postage stamps, having original artwork thereon, will be sold, said original artwork being created by members of said organization;
providing guidelines to said organization regarding the manner in which said original artwork is to be created;
creating said original artwork;
collecting said original artwork;
offering said postage stamps, having said original artwork thereon, for sale;
receiving orders for said postage stamps;
causing said original artwork to be put onto said postage stamps;
processing payment for said orders; and
delivering said postage stamps to purchasers thereof.

2. A method as defined by claim 1 wherein said organization is a school and said members of said organization are students enrolled in said school.

3. A method as defined by claim 1 wherein said organization is a non-profit organization.

4. A method as defined by claim 1 wherein said step of collecting said original artwork includes reducing said original artwork to a digital form and transferring said artwork electronically to a computer wherein said original artwork is stored in memory forming part of said computer.

5. A method as defined by claim 4 wherein said step of causing said original artwork to be put onto postage stamps includes accessing said original artwork stored in said memory and manipulating said artwork so that it is in a proper, final state to be imaged onto a postage stamp.

6. A method as defined by claim 2 wherein said step of creating said original artwork includes causing each student to create his or her own original artwork and said step of causing said original artwork to be put onto said postage stamps includes putting each of said students original artwork onto said postage stamps; and wherein said step of offering said postage stamps, having said original artwork thereon, for sale includes offering postage stamps bearing each of said student's artwork thereon, for sale.

7. A method as defined by claim 5 wherein said step of providing guidelines includes the steps of:
providing promotional material to said school; and
supplying said school with one stamp form for each of said students upon which to produce said original artwork.

8. A method as defined by claim 6 wherein said step of offering said postage stamps for sale includes providing each student with a personal promotional brochure showing at least one image of a stamp having said student's original artwork thereon and at least one order form.

9. A method as defined by claim 6 wherein said step of collecting said original artwork includes performing one of scanning and digitally photographing said original artwork and electronically transferring said original artwork to a computer wherein said original artwork is stored in memory forming part of said computer.

10. A method of offering and producing custom postage stamps comprising the steps of:
providing a kiosk having a computer programmed to allow a user to design and print custom postage stamps;
inputting into said computer graphic information corresponding to indicia a user desires to have imaged onto a postage stamp;
displaying said postage stamp having said graphical image thereon on a screen in communication with said computer;
paying for a desired quantity of said postage custom stamps; and
causing said custom postage stamps to be printed at said kiosk.

11. A method as defined by claim 10 prior to said step of inputting, said method further including the step of creating a caricature of at least one individual and said step of inputting includes converting said caricature into a digital format and storing said caricature in said digital format into memory forming part of said computer, said caricature corresponding to said indicia said user desires to have imaged onto said postage stamp.

12. A method as defined by claim 1 comprising the further step of offering a collectors' edition version of each students stamp for purchase.

13. A method as defined by claim 1 further comprising the step of providing sales incentives to said members of said organization.

14. A method as defined by claim 1 further comprising the step of selecting at least one of said pieces of original artwork for artistic quality.

15. A method as defined by claim 1 wherein said organization includes several organizations and said method comprises the further step of selecting at least one most artistic piece of original artwork from said several organizations.

16. A method as defined by claim 10 further comprising the step of providing a photo booth in said kiosk and said step of inputting includes downloading pictures from said photo booth into said computer.
